(19) United States
(12) Patent Application Publication
(10) Pub. No.: US 2004/0216311 A1
(43) Pub. Date: Nov. 4, 2004

(54) Razor handle assembly

(75) Inventor: Thomas A. Follo, Milford, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH (US)

(21) Appl. No.: 10/801,844

(22) Filed: Mar. 16, 2004

Related U.S. Application Data
(60) Provisional application No. 60/458,675, filed on Mar. 28, 2003.

(51) Int. Cl. B26B 21/52

(52) U.S. Cl. 30/526

(57) ABSTRACT

In a razor handle assembly, a first handle section includes a first body portion and a second handle section includes a second body portion, the first and second body portions generally being mirror images of one another. The first and second handle sections are coupled together and cooperate to form a closed end and a generally opposite open end. A head assembly is interposed between the first and second body sections at the open end and includes a retainer for releasably mounting a disposable razor cartridge to a razor handle. A core is positioned between the first and second body portions and has an end adjacent to the dosed end formed by the first and second handle sections.

### CROSS-REFERENCE TO RELATED APPLICATIONS

This application is entitled to the benefit of and incorporates by reference essential subject matter disclosed in Provisional Patent Application No. 60/458,675 filed on Mar. 28, 2003.

### FIELD OF THE PRESENT INVENTION

The present invention is generally related to shaving implements and is more particularly related to handle portions of shaving implements.

### BACKGROUND OF THE PRESENT INVENTION

Shaving comfort has become an ever increasingly important aspect of modem razor design. One factor that greatly contributes to shaving comfort is the configuration of the razor handle. Historically, the handles have been treated as nothing more than mere supports for the blade carrying razor cartridge. As such, little thought or ingenuity has gone into their design to make them more user friendly.

Recently, efforts have been made to improve razor handle design by developing contoured shapes that more closely follow the contours of a user's grip. However, these handles are often formed from hard smooth materials making them slippery and difficult to manipulate in a wet shaving environment. Attempts to add ribbed surfaces or to use dissimilar materials such as rubber on a surface have been made. However, generally, the dissimilar material is not applied all around the razor thereby having the effect of enhancing the grip when a razor is held in one manner but not in another.

Prior art razor handles are typically assembled in a top to bottom fashion with two usually metallic or hard plastic handle sections coupled together forming the complete outer periphery of the handle. Enhancements to make the razor easier to grip usually involve small areas of elastomeric material extending through small apertures in the handle. While this provides some level of increased gripping it generally does not sufficiently address the problem of providing adequate handling comfort during a shaving operation.

Based on the forgoing it is the general object of the present invention to overcome or improve upon the problems and drawbacks associated with the prior art.

### SUMMARY OF THE INVENTION

The present invention resides in one aspect in a razor handle having first and second side sections, the first side section defining a first base portion and the second side section defining a second base portion. The first and second base portions are mirror images of each other and when coupled together cooperate to form a dosed end and a generally opposite open end. The razor handle further includes a core interposed between the first and second handle sections, the core having an end adjacent the closed end of the handle sections. A head assembly, defining means for releasably coupling a razor cartridge thereto, is also interposed between the first and second handle sections and positioned in the open end thereof. Attachment means for coupling the first and second razor sections to one another are also provided.

Preferably, the attachment means include at least one stud extending from one of the first and second body portions and being receivable in an aperture defined by the other of the first and second body portions. It is also preferable that the core be formed from a material providing suitable gripping characteristics such as, but not limited to, rubber or an elastomeric polymer.

In the preferred embodiment of the present invention, the first and second handle sections are formed from die cast metal, and instead of a single stud as described above retaining the handle sections together, the attachment means includes a plurality of studs, at least one of which extends through the head assembly and another of which the core to properly position the head assembly and the core relative to the first and second handle sections as well as to aid in retaining them in the razor handle.

Side inserts are also preferably provided and are coupled to each of the first and second handle sections. In the preferred embodiment of the present invention, a pair of side inserts is provided with each defining an extension projecting outwardly from an inner surface thereof. The extension is frictionally engageable with a complementarily shaped mating aperture defined by each of the first and second handle sections. Once assembled, the side inserts are approximately perpendicular to outer surfaces defined by the core. Similarly to the core, the side inserts are also made from a material providing suitable gripping characteristics such as, but not limited, to rubber or an elastomeric polymer.

### BRIEF DESCRIPTION OF THE DRAWINGS

FIG. 1 is a side view of a razor including a handle embodying the present invention.

FIG. 2 is a plan view of the razor of FIG. 1.

FIG. 3 is an exploded parts view of the razor of FIG. 1.

### DETAILED DESCRIPTION OF THE PREFERRED EMBODIMENTS

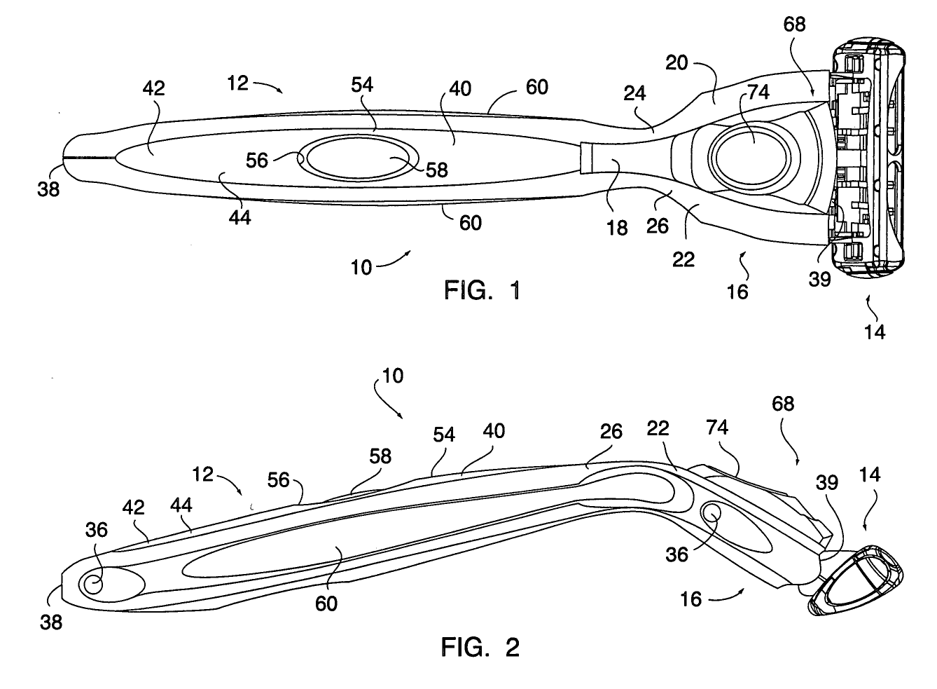

As shown in FIG. 1, a razor generally designated by the reference number 10 includes a handle, generally designated by the reference number 12, and a disposable shaving cartridge 14 releasably attached to a head portion 16 of the handle. An aperture 18 is defined by the handle 14 and is adapted to receive a portion of a caddy (not shown) to releasably retain the razor thereon when not in use.

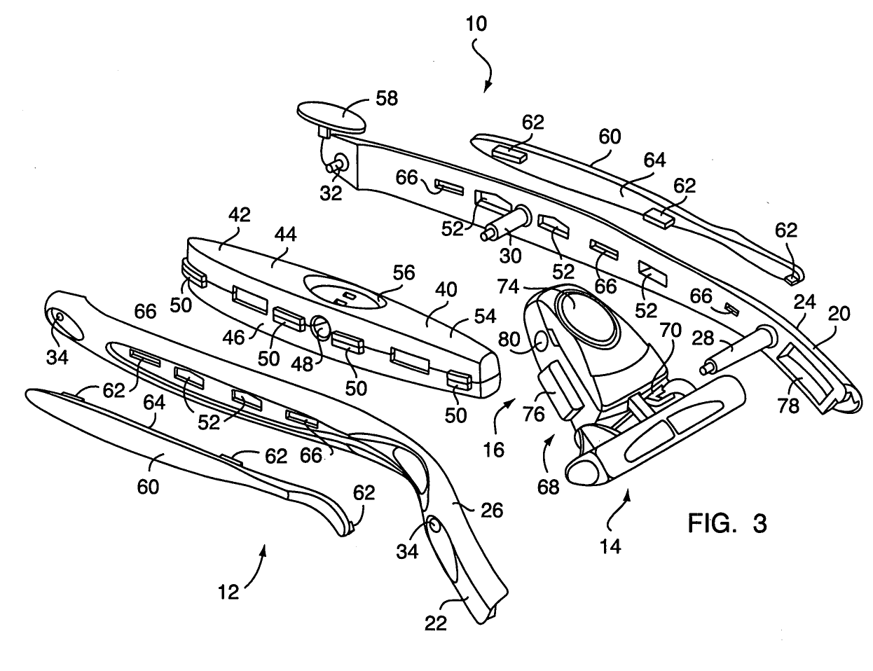

As shown in FIG. 3, the handle 12 includes a first handle section and a second handle section, generally designated by the reference numbers 20 and 22 respectively. The first handle section 20 includes a first body portion 24. Likewise, the second handle section 22 includes a second body portion 26. The first and second body portions, 24 and 26 respectively, are preferably formed from a suitable material, such as, but not limited to, die cast aluminum, and are generally mirror images of one another.

In the illustrated embodiment, the first handle section 20 includes three studs 28, 30, and 32 projecting outwardly from the first body portion 24. The ends of the studs 28, 30 and 32 are each received in an aperture 34 defined by the second handle section 22. Referring back to FIG. 1, when assembled, rivets 36 (only two shown) are positioned in the apertures 34, thereby coupling the first and second handle sections, 20 and 22 respectively, together. Once the first and second handle sections, 20 and 22 respectively, are attached to one another, they cooperate to define, as best seen in FIG. 1, a closed end 38, and an open end 39.

While three studs 28, 30 and 32 and three apertures, have been shown and described, the present invention is not limited in this regard as more or less than three studs and apertures can be employed without departing from the broader aspects of the present invention. In addition, the studs have been shown as extending from the first body portion 24; however, the present invention is not limited in this regard as the studs can protrude from the second body portion 26 or from both the first and second body portions. The same is true for the apertures 34; they can all be defined by either of the first and second handle sections 20 and 22, or each handle section can define a portion of the apertures. Furthermore, while rivets 36 have been shown and described, the present invention is not limited in this regard as other fastening methods such as adhesives, screws, solder or welding, can be employed.

Referring to FIG. 3, the handle 12 includes a core 40 interposed between the first and second body sections 20 and 22 respectively. The core includes an end 42 adjacent to the closed end 38 formed by the first and second handle sections 20 and 22. The core 40 is made from a suitable material, such as an elastomer, elastomeric polymer, or a polymer. The core 40 includes first and second core sections 44 and 46 that are attached to one another via an adhesive, with each defining a portion of an aperture 48 through which the stud 30 passes when the handle 12 is assembled. The core 40 defines a plurality of ribs 50 which extend along generally opposite side surfaces thereof. The ribs 50 are received in complementarily shaped grooves 52 defined by each of the first and second handle sections 20 and 22 respectively. The grooves 52 in cooperation with the ribs 50 aid in appropriately positioning the core 40 relative to the first and second handle sections 20 and 22 respectively. In addition, in the illustrated embodiment, an upper surface 54 of the core 40 defines a recess 56 for receiving a similarly shaped emblem plate 58 having indicia thereon. However, the present invention is not limited in this regard as the recess 56 and emblem plate 58 can be omitted without departing from the broader aspects of the present invention. In addition, while first and second core sections 44 and 46 have been shown and described, the present invention is not limited in this regard as the core can be formed from a single piece of material.

Still referring to FIG. 3, the handle 12 includes a pair of side inserts 60 each having three projections 62 extending outwardly from an inner surface 64 of the side insert. The projections 62 each frictionally engage a complementarily shaped slot 66 defined by each of the first and second handle sections 20 and 22 respectively. Each side insert 60 is made from a suitable material such as, but not limited to, an elastomer, an elastomeric polymer, or a polymer. In order to permanently secure the side inserts 60 to the first and second handle sections 20 and 22, an adhesive can be employed. While projection 62 and slots 66 have been shown and described, the present invention is not limited in this regard as the side inserts can simply be adhesively attached to the handle section without departing from the broader aspects of the present invention.

A head assembly generally designated by the reference number 68 is interposed between the first and second handle sections 20 and 22 respectively, and is positioned in the open end 39 formed thereby. The head assembly 68 includes a cartridge retainer 70 for releasably retaining the razor cartridge 14 thereon. To eject or attach the razor cartridge 14 to the handle 12, a button 74 is moved forward, thereby causing the razor cartridge to release from the handle. The head assembly 68 includes a pair of generally opposed bosses 76 (one shown) that engage complementarily shaped recesses 78, defined by each of the first and second handle sections 20 and 22 respectively. The mating of the bosses 76 with the recesses 78 causes the head section 68 to be properly positioned in the razor handle 12. In addition, the head section 68 defines an aperture 80 projecting therethrough which the stud 28 passes, further fixing the position of the head section. However, the present invention is not limited in this regard as the stud 28 does not have to pass through the head section 68. To be mechanically fixed, the head section 68 can, in addition or alternatively, be adhesively bonded to the first and second handle sections 20 and 22, respectively. Referring back to FIG. 1, the aperture 18 is defined by the first and second handle sections, 20 and 22 respectively, the head section 68 and the core 40.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A razor handle assembly comprising:
a first handle section having a first body portion;
a second handle section having a second body portion, said first and second body portions being mirror images of one another;
attachment means for coupling said first and second handle sections together, so that said first and second handle sections cooperate to form a closed end and an open end generally opposite said closed end;
a head assembly interposed between said first and second body sections at said open end, said head assembly defining means for releasably retaining a razor cartridge thereon; and
a core interposed between said first and second body sections, said core having an end adjacent said closed end.

2. A razor handle assembly as defined by claim 1 wherein:
said attachment means includes at least one stud projecting outwardly from one of said first and second handle portions, and at least one aperture in the other of said first and second handle portions, said aperture being adapted to receive an end of said stud; and
fastening means for securing said end of said stud in a respective one of said apertures.

3. A razor handle as defined by claim 2 wherein:
said at least one stud includes three studs each spaced away from the next successive stud and projecting outwardly from one of said first and second handle portions; and
said at least one aperture includes at least three apertures each adapted to receive an end of one of said studs.

4. A razor handle as defined by claim 2 wherein said fastening means includes a rivet.

5. A razor handle as defined by claim 2 wherein said fastening means includes an adhesive.

6. A razor handle as defined by claim 1 wherein said first and second handle sections are formed from metal.

7. A razor handle as defined by claim 6 wherein said first and second handle sections are formed from die cast metal.

8. A razor handle as defined by claim 3 wherein one of said studs extends through said head assembly and another of said studs extends through said core.

9. A razor handle as defined by claim 1 wherein said core is formed from an elastomeric polymer.

10. A razor handle as defined by claim 1 wherein said core includes a first core section coupled to a second core section.

11. A razor handle as defined by claim 1 further comprising a pair of side inserts, one coupled to each of said first and second razor sections, said side inserts being positioned generally opposite one another.

12. A razor handle as defined by claim 11 wherein:
each of said side inserts defines at least one projection extending outwardly from an inner surface of said side insert; and wherein
each of said projections is frictionally receivable in a complementarily shaped aperture defined by each of said first and second handle sections.

13. A razor handle as defined by claim 12 wherein each of said side inserts is formed from an elastomeric polymer.

14. A razor handle as defined by claim 1 wherein:
said head assembly defines a pair of generally opposed bosses projecting outwardly from side surfaces thereof; and wherein
each of said handle sections includes a mating recess for receiving one of said bosses.

15. A razor handle as defined by claim 11 wherein each of said side inserts defines a plurality of raised portions for improving a user's grip on said razor handle.

16. A razor handle as defined by claim 1 wherein said core defines a pair of generally opposed, exposed gripping surfaces extending between said first and second handle sections.

17. A razor handle as defined by claim 1 wherein said razor handle includes an aperture bounded by said first and second handle sections, an end of said core, and an end of said head assembly, said aperture being adapted to engage at least one extension projecting outwardly from a razor caddy, thereby releasably coupling said razor handle to said razor caddy.

18. A razor handle comprising:
a first metallic handle portion having a first body section;
a second metallic handle portion having a second body section, said first and second body sections being mirror images of one another;
said first handle section being coupled to and cooperating with said second handle section to form a closed end and a generally opposite open end;
an elastomeric plastic core positioned between said first and second handle sections and having generally opposed, exposed gripping surfaces, said core having an end located adjacent to said closed end; and
a head assembly interposed between said first and second body sections at said open end, said head assembly defining means for releasably retaining a razor cartridge.

19. A razor handle as defined by claim 18 further comprising a pair of elastomeric side inserts each coupled to one of said first and second handle sections, each of said side inserts defining an exposed outer surface approximately perpendicular to said exposed gripping surfaces defined by said core.

20. A razor handle as defined by claim 18 wherein said razor handle includes an aperture bounded by said first and second handle sections, an end of said core, and an end of said head assembly, said aperture being adapted to engage at least one extension projecting outwardly from a razor caddy, thereby releasably coupling said razor handle to said razor caddy.
